(19) United States
(12) Patent Application Publication
(10) Pub. No.: US 2026/0024381 A1
(43) Pub. Date: Jan. 22, 2026

(54) A METHOD AND A SYSTEM FOR DETERMINING CONDITION OF A COMPONENT OF A REMOTELY OPERATED VEHICLE

(71) Applicant: AutoStore Technology AS, Nedre Vats (NO)

(72) Inventors: Jørgen Djuve Heggebø, Langhus (NO); Asheesh Saraswat, Heggedal (NO)

(21) Appl. No.: 18/875,421

(22) PCT Filed: May 26, 2023
(86) PCT No.: PCT/EP2023/064222

§ 371 Date: Dec. 16, 2024

(30) Foreign Application Priority Data
Jun. 17, 2022 (NO) 20220692

(51) Int. Cl. G07C 5/00; B65G 41/02; G06T 7/00; G06V 20/52

(52) U.S. Cl. CPC G07C 5/008; B65G 41/02; G06T 7/001; G06V 20/52

(57) ABSTRACT

The invention relates to a method for determining a condition of a component of a remotely operated vehicle (501) operating on a rail system (108) of an automated storage and retrieval system (1) for goods holders (106). The method comprises selecting the component of the remotely operated vehicle (501), recording an image of the component. identifying the component on the basis of the recorded image and determining condition of the identified component using the recorded image. The invention further relates to a system (510) for determining a condition of a component and an automated storage and retrieval system (1) comprising said system (510).

The present invention relates to a method for determining a condition of a component of a remotely operated vehicle, to a system for determining a condition of a component and to an automated storage and retrieval system comprising said system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a, 404a for vertical transportation of storage containers 106, e.g. raising a storage container 106 from, and lowering a storage container 106 into, a storage column 105. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station. The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system (shown in FIG. 1) which typically is computerized and which typically comprises a database for keeping track of the storage containers 106.

In the context of storage systems, such as that shown in FIG. 1, different kinds of system maintenance may be implemented. Historically, the most common of these is corrective maintenance, where components are successively replaced as they break down. Corrective maintenance ensures that components are used until their end of life, but its downside is substantial system downtime due to unplanned component replacement.

Alternatively, the system may be preventively maintained. Within the frame of a preventive maintenance program, the component is replaced in accordance with a predetermined schedule before its end of life. Consequently, component breakdown may be eliminated altogether. Preventive maintenance minimises unexpected breakdowns and all disadvantages associated therewith, but generates increased costs.

Predictive maintenance amalgamates best aspects of corrective maintenance and preventive maintenance by maximizing the useful time of components while reducing the frequency of breakdowns. In order to achieve this, the maintenance efforts are performed at the most optimal moment. In order to closely determine the most opportune moment for performing maintenance, Weibull distribution may be used. In maintenance engineering, Weibull distribution is a well-known method of modelling component lifetime distribution and may be implemented in real life systems such as the storage system of FIG. 1.

In a related context, WO2021/198093 discloses a conventional storage system that also includes a service station for performing maintenance on the storage system components, e.g. robots. The system comprises a central computer system and a service regime manager configured to retrieve condition-based information linked to the components of the storage system, and to, based on the retrieved condition-based information, create a service regime and send this service regime to the service station.

Unexpected events may occur in the context of system maintenance, such as end-customer, without informing system manufacturer, replacing components with new ones of unknown origin or end-customer performing maintenance on its own initiative. As a result, manufacturer's maintenance records become incomplete. In consequence, information in the originally planned maintenance schedule becomes inaccurate.

Inadequate component maintenance could result in component damage. In order to timely detect such damage, service operators must have considerable skills and experience. In the related context, it is beneficial that damage detection process is performed uniformly across the service operator team.

It is desirable to provide a solution that solves or at least mitigates this and other problems belonging to the prior art.

### SUMMARY OF THE INVENTION

The present invention is set forth and characterized in the independent claims, while the dependent claims describe other characteristics of the invention.

First aspect of the invention relates to a method for determining a condition of a component of a remotely operated vehicle operating on a rail system of an automated storage and retrieval system for goods holders, said method comprising:
selecting the component of the remotely operated vehicle,
recording an image of the component,
identifying the component on the basis of the recorded image,
determining a condition of the identified component using the recorded image.

A solution in accordance with the above method contributes to achieving a uniform component inspection. More specifically, operator's involvement can be greatly reduced, even eliminated altogether, thus realizing a highly standardized component inspection procedure.

In addition, the method aids to a more accurate determination of the condition of the vehicle component and to more accurately schedule component maintenance. As a result, component diagnostics is improved.

In some embodiments, the method could leverage machine learning to process the vast amounts of data that are generated and to recognize patterns and/or perhaps extract deep information that a less sophisticated technology would not be able to identify.

Moreover, the method could also be used for troubleshooting a malfunctional remotely operated vehicle. In a related context, the method may be used to obtain a confirmation that a certain remotely operated vehicle is healthy and operational. This is particularly useful in situations where a general error code attributable to either of the remotely operated vehicle/goods holder/storage grid is generated.

A second aspect of the invention relates to a system for determining a condition of a component of a remotely operated vehicle operating on a rail system of an automated storage and retrieval system for goods holders.

Advantages discussed above in connection with the method may even be associated with the corresponding system and are not further discussed but may apply equally. For the purposes of this application, the term “container handling vehicle” used in “Background and Prior Art”-section of the application and the term “remotely operated vehicle” used in “Summary of the Invention”—and Detailed Description of the Invention”—sections both define a robotic wheeled vehicle provided with a lifting device and operating on a rail system of the framework structure being part of an automated storage and retrieval system.

Analogously, the term “storage container” used in “Background and Prior Art”—section of the application and the term “goods holder” used in “Summary of the Invention”—and “Detailed Description of the Invention”—sections both define a receptacle for storing items, said receptacle being engageable by the lifting device of the robotic wheeled vehicle. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

Finally, the remotely operated vehicles of the invention typically operate on a rail system arranged across the top of an automated storage and retrieval system for goods holders. This configuration is also shown in FIG. 1. However, it is equally conceivable that the remotely operated vehicle operates on a rail system arranged side-by-side with the storage grid such that goods holders are laterally inserted to/extracted from the storage grid.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of an automated storage and retrieval system belonging to prior art.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4a is a perspective side view of a system for determining a condition of a component of a remotely operated vehicle.

FIG. 4b is a view from above of the system shown in FIG. 4a.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

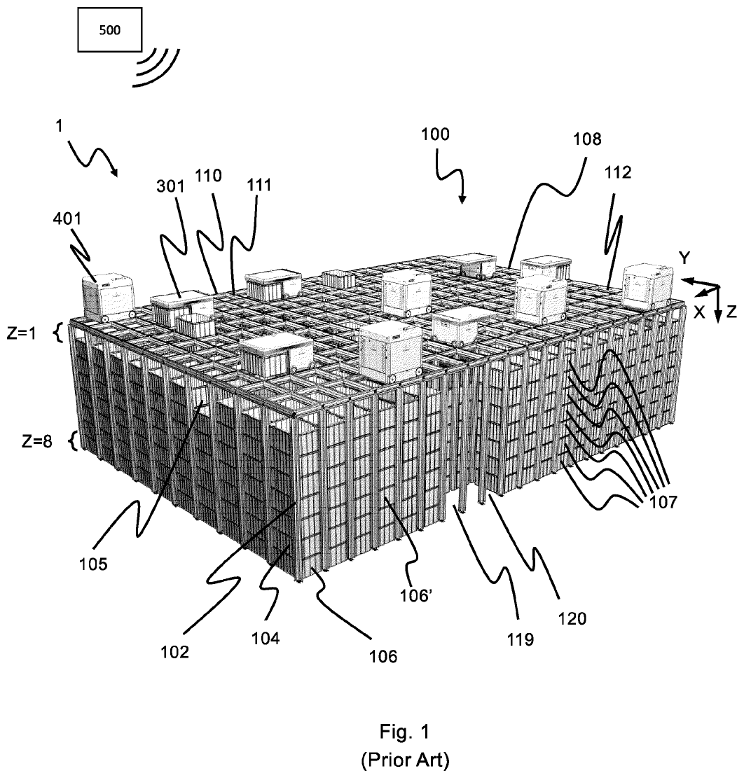

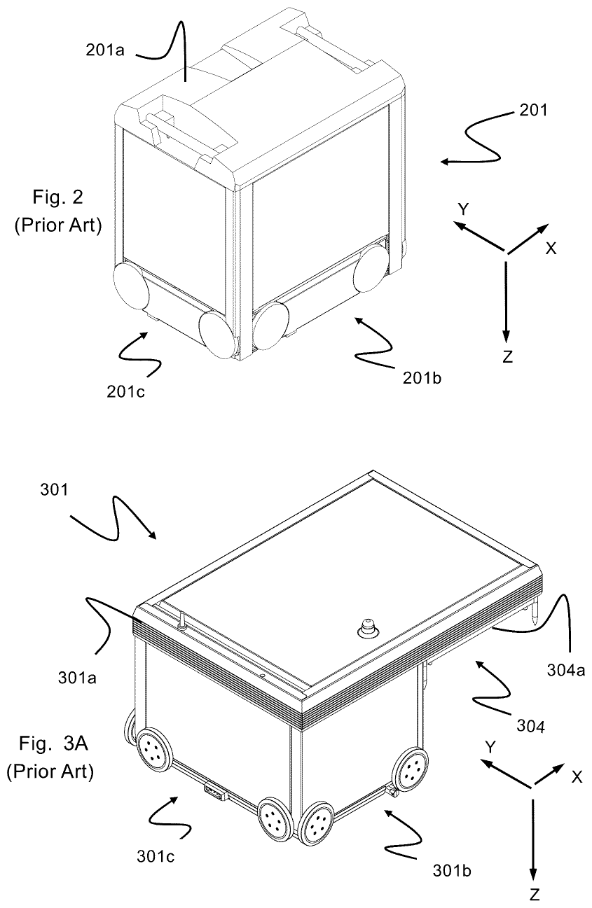

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

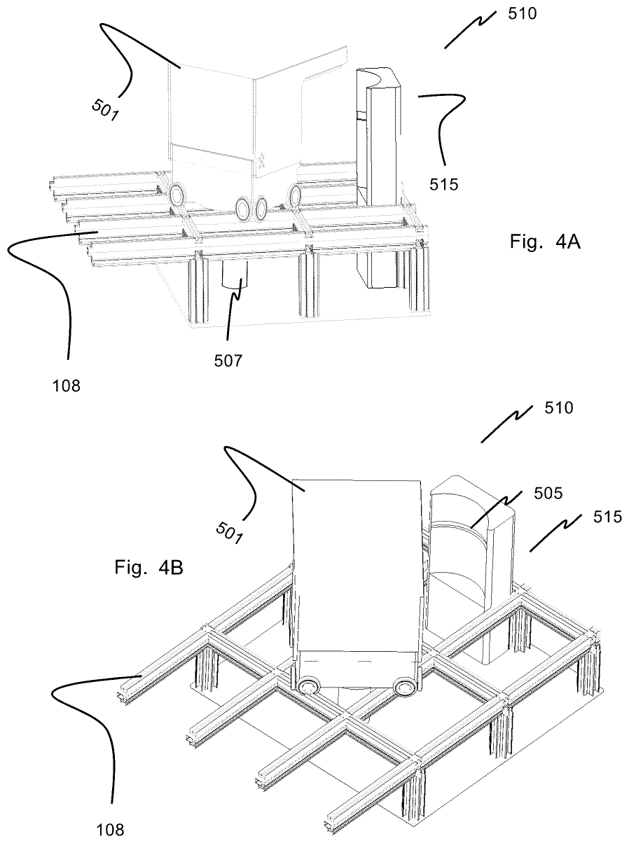

FIG. 4a is a perspective side view of a system 510 for determining a condition of a component of a remotely operated vehicle 501. The vehicle 501 is positioned adjacent an inspection device 515. Once the vehicle 501 is in correct position, a method for determining a condition of a component of the remotely operated vehicle 501 may be effected. Said method comprises selecting the component of the remotely operated vehicle 501 and recording an image of the component. Subsequently, the component is identified on the basis of the recorded image, whereupon a condition of the identified component is determined using the recorded image. Here, identifying of the component is to be construed as identifying the particular component being part of the vehicle 501 being inspected. The identification of the component will enable track-keeping of each vehicle's 501 component composition. This could be used to issue specific, vehicle-related maintenance tasks or to adjust the time interval between two successive vehicle inspections and/or component replacements. In an embodiment, identifying the component on the basis of the recorded image could comprise reading of ID-data associated with the component. Here, said identification process could be based on Optical Character Recognition (OCR). FIG. 4b is a view from above of the system shown in FIG. 4a.

An exemplary sequence for a scheduled maintenance task starts with positioning of the vehicle 501 adjacent the inspection device 515 and, optionally, removing covering plates so that the different vehicle components become visible. Subsequently, an operator opens the software application on a handheld device (discussed further below) and connects the vehicle 501 to be inspected to the system 510. The system 510 then prepares correct maintenance procedure for the components of the vehicle's submodules (move, lift, track shift, charge, . . . ) and retrieves appropriate operational data or batch data. Subsequently, the system 510 guides the operator through the steps of the maintenance procedure, where image recording takes place. If deviations are detected during the maintenance procedure, more specific camera views are requested based e.g. on operational data or batch data. Where appropriate, defect components are replaced and component maintenance record is suitably updated. In such a case, a new image of the component is recorded and stored in the system for future reference.

The obtained component information will also be useful for improving the manufacturing quality of the individual components and/or be leveraged to produce a realistic estimate of operational costs in a planning phase of a new automated storage and retrieval system (shown in FIG. 1).

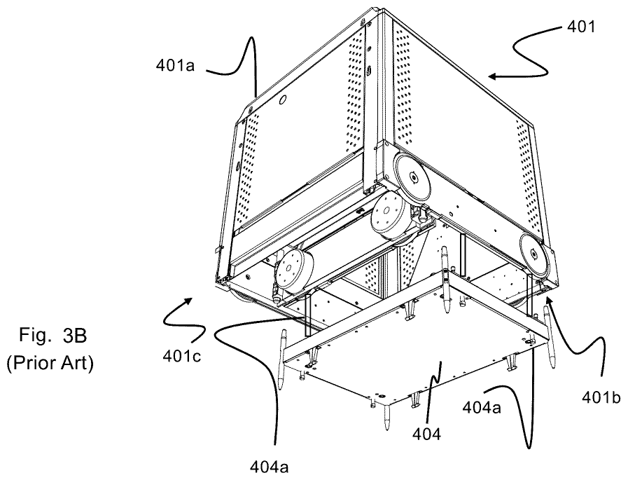

Said component could be any one of a wheel of the vehicle 501, a lifting device (304, 404; shown in FIGS. 3a-3b) for vertical transportation of goods holders, a gripper element, a gearbox, a motor belt or a goods holder contact sensor.

Typically, a determined condition of the component is remaining useful life (RUL). Alternatively, a determined condition of the component is probability of component failure within a given time window.

Hence, the system 510 could assist the operator in estimating the degradation rate/RUL of each individual component. By using operational data, the change of condition between two successive inspections is determined. By also considering the normal degradation rate for that particular component, a RUL-estimate may be calculated. This information could be used to bring forth or postpone replacement of the individual component.

A solution in accordance with the above method contributes to achieving a uniform component inspection. More specifically, operator's involvement can be greatly reduced, even eliminated altogether, thus realizing a highly standardized component inspection procedure. In addition, the method aids to a more accurate determination of the condition of the vehicle component and to more accurately schedule component maintenance. As a result, component diagnostics is improved.

The method could also be used for troubleshooting a malfunctional remotely operated vehicle 501. In a related context, the method may be used to obtain a confirmation that a certain remotely operated vehicle 501 is healthy and operational. This is particularly useful in situations where a general error code attributable to either of the remotely operated vehicle/goods holder/storage grid is generated by the system 1.

In the above context, a troubleshooting sequence would typically start with removing the vehicle 501 from grid in response to an error code. Subsequently, the operator would activate the inspection device 515 and enter vehicle-ID. The device 515 then retrieves and analyzes different types of data (for instance operational and/or batch data) and returns information on which component(s) of the vehicle 501 could be compromised and should be more thoroughly inspected. Subsequently, an image of the component is recorded. The information contained in the image could also be used to confirm identity of the particular vehicle 501. Upon analysis, the inspection device would determine whether to release the vehicle 501 to the grid, or if the vehicle indeed is malfunctional and should remain off-grid.

Where necessary, selecting the component of the remotely operated vehicle 501 is preceded by identifying the remotely operated vehicle 501, for instance by means of the system 510 shown in FIGS. 4a-4b. Said identifying of the remotely operated vehicle 501 normally comprises recording an image of the vehicle 501, specifically sections of the vehicle 501 where vehicle ID-information is provided.

In an embodiment, readily combinable with previously discussed embodiment, further information regarding a vehicle component may be collected by a sensor arranged at the remotely operated vehicle 501. By way of example, the sensor may be a proximity sensor or a vibration sensor.

In an embodiment, determining a condition of the identified component comprises using operational data associated with the component. By way of example, operational data may be data collected during vehicle 501 testing phase or data collected while the vehicle 501 operates.

In one embodiment, based on operational data, a system 510 shown in FIG. 4a will guide an operator to focus into areas of interests. For example, if the system 510, based on the operational data, discovers lifting problem for a particular vehicle 501, the system 510 will ask for detailed view of specific components of the vehicle 501. If compromised vehicle components are subsequently identified, the system 510 will provide this information to the operator.

In an embodiment, if defect components are discovered by the operator during manual vehicle inspection, said defect components having been overlooked by the inspection device 515, the operator would enter this information in the system 510, bringing the system up-to-date.

In one embodiment, the collected image data regarding the component is registered on a memory unit (not shown) of the remotely operated vehicle 501. Advantageously, the registered data may be transferred from the memory unit to a central processing unit while the remotely operated vehicle 501 is being charged. Data transfer may occur wirelessly using a suitable protocol or by tethering the vehicle 501 to an external device. In a preferred embodiment, data transfer is cumulative—only new data generated between two consecutive data transfers is transferred.

In another embodiment, determining a condition of the identified component comprises comparing freshly recorded image of the component with previously recorded image of said component. Typically, relevance of the previously accumulated image data is improved by cleaning said data. Data cleaning is the process of identifying and replacing incomplete or inaccurate records from a data set.

In yet another embodiment, determining a condition of the identified component comprises using batch information associated with said component. In this way, the time interval between two successive inspections and/or component replacements may be adjusted. More specifically, some batches could have known issues and components belonging to these batches should be replaced immediately. On the other hand, components belonging to batches having superior quality could have an extended useful life.

In a further embodiment, determining a condition of the identified component comprises taking into account environmental conditions, such as air temperature and/or air humidity associated with the automated storage and retrieval system 1.

In a related context, information about the condition of the component could be used to reassign the vehicle 501 having the component which appears to be compromised from the data set values to a task commensurate with the current condition of said component, typically requiring less effort/accuracy/speed compared to a normally assigned task. By way of example, a vehicle 501 that has been identified as having a component which potentially appears to be compromised could be instructed only to collect empty goods holders 106 whereas previously it might have collected all types of goods holders including ones with a heavy/uneven load. Alternatively and as discussed above, information about the condition of the component could be used to replace the component followed by appropriate update of the maintenance records for the particular vehicle 501.

In an embodiment, a time for next vehicle maintenance could be set on the basis of the determined condition of the vehicle component. Again, this could be followed by update of the maintenance records for the particular vehicle 501.

With reference to above-discussed embodiments, if a condition of the identified component is not satisfactory, an image of a selected section of the identified component could be recorded. In other words, it is conceivable to zoom-in on the certain section of the component. Said section of the component is selected based on at least one of operational data associated with the component, batch information associated with the component and environmental conditions associated with the automated storage and retrieval system 1.

In one embodiment (not shown), an image of the vehicle component is recorded by means of camera of a handheld device associated with an operator. In the same context, information regarding the identified component is presented to the operator on a display of the handheld device.

In another embodiment (shown in FIGS. 4a-4b), an image of the vehicle component is recorded by means of at least one fixed-position camera 505. Still with reference to FIGS. 4a-4b, the remotely operated vehicle 501 is arranged to be rotated prior to recording of the image of the component. In an alternative embodiment (not shown), an image of the component is recorded by means of at least one camera provided on a movable robotic arm.

As stated above, FIG. 4a is a perspective side view of a system 510 for determining a condition of a component of a remotely operated vehicle 501.

The system 510 comprises the inspection device 515 comprising a camera 505 for recording an image of the component, an identifying means configured to identify the component on the basis of the recorded image and a determining means arranged to determine condition of the identified component using the recorded image.

In the shown embodiment, the inspection device 515 of the system 510 comprises a fixed-position camera 505. The shown system 510 comprises means for rotating the remotely operated vehicle 501. Said means is a rotary telescopic shaft 507 adapted to engage with frame of the vehicle 501, said shaft 507 being rotatable about its longitudinal axis. Accordingly, the vehicle 501 is first elevated such that the vehicle wheels disengage from the rail 108 whereupon a rotary motion of the shaft 507 turns the vehicle 501 and exposes a different section of the vehicle 501 to the fixed-position camera 505. In an alternative embodiment (not shown), the camera is provided on a movable robotic arm.

In another embodiment (not shown), the inspection device is a handheld device comprising a display.

In an alternative embodiment, the system may facilitate component replacement procedure. More specifically, during the useful life of the storage and retrieval system 1, there could be several vehicle redesigns, in addition to structural modifications of the individual components resulting in many different replacement operation procedures. The system 510 will help identify the applicable procedure for the particular component/vehicle setup and present relevant information to the operator, or, in a more advanced version, guide the operator step-by-step through the component replacement procedure, optionally using Virtual Reality.

In general, a so-called high-level data for the vehicle components is readily available. By way of example, such high-level data is how much bins a vehicle has lifted and/or moved, how many direction changes the vehicle has performed, or how many charge cycles the vehicle has completed. Data regarding the environmental condition the vehicles are operating in, like ambient temperature and/or pressure, is also readily available. This data is typically used in a machine learning-based model to improve accuracy of a component RUL-prediction.

On a general level, a lot of data needs to be collected to obtain satisfactory results. Here, freshly collected data will be utilized in a machine learning-based model to further improve accuracy of said RUL-prediction.

One way to implement said machine learning-based model is to establish some kind of expected component condition for a given, vehicle-related interval, for instance expected component condition if vehicle had totally lifted 0-10 km, 10-20 km and so on. Vehicle component images corresponding to these intervals are associated with said intervals such that the machine learning-based model may be trained. In this training process, each image is labelled with the corresponding high-level data value comprising an interval with an associated RUL-value. By collecting a lot of data, the model becomes more fine-meshed, the length of the intervals is reduced and the accuracy of the RUL-prediction is increased.

Accordingly, in an inspection, high-level data for the vehicle and its components is initially collected. Afterwards, an image of the vehicle component is recorded by means of an image-recording device. The recorded image is subsequently run through the machine learning algorithm which will try to determine which component-related interval the recorded image of the vehicle component fits into. Then, the estimated interval (from the model) is compared with the actual interval (from the high-level data) to see if the values are discrepant. The level of discrepancy provides information on the current quality of the model. If protocols of previous component inspections exist, it is even possible to verify if the condition of the component follows the expected trajectory or the component wear has accelerated. Finally, the collected data including the labels (high-level data) as well as the registered images are stored for future use.

In the preceding description, various aspects of the method/system for determining a condition of a component of a remotely operated vehicle have been described according to the invention and with reference to the illustrative embodiments. For purposes of explanation, specific numbers, systems and configurations were set forth in order to provide a thorough understanding of the system and its workings. However, this description is not intended to be construed in a limiting sense.

Various modifications and variations of the illustrative embodiment, as well as other embodiments of the method/system, which are apparent to persons skilled in the art to which the disclosed subject matter pertains, are deemed to lie within the scope of the present invention.

### LIST OF REFERENCE NUMBERS

1 Storage and retrieval system
100 Framework structure
101 Storage cell
102 Upright members of framework structure
102′ Upright members of the module
104 Storage grid
105 Storage column
106 Storage container/Goods holder
106′ Particular position of storage container
107 Stack of storage containers
108 Rail system
110 Parallel rails in first direction (X)
111 Parallel rails in second direction (Y)
112 Access opening
119 First port column
200 Module
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
304 Lifting device of a cantilever-based container handling vehicle
304a Lifting frame part
401 Container handling vehicle belonging to prior art
401a Vehicle body of the container handling vehicle 401
401b Drive means in first direction (X)
404 Lifting device of a cavity-based remotely operated vehicle
404a Lifting frame part
501 Remotely operated vehicle of the present invention
505 Camera
507 Rotary telescopic shaft
510 System for determining a condition of a component
515 Inspection device
X First direction
Y Second direction
Z Third direction

1. A method for determining a condition of a component of a remotely operated vehicle operating on a rail system of an automated storage and retrieval system for goods holders, said method comprising:
selecting the component of the remotely operated vehicle,
recording an image of the component,
identifying the component based on the recorded image, and
determining a condition of the identified component using the recorded image.

2. The method of claim 1, wherein the determining of a condition of the identified component comprises using operational data associated with the component, the operational data associated with the component comprising data collected during a vehicle testing phase of the remotely operated vehicle or data collected while the remotely operated vehicle operates.

3. The method of claim 1, wherein the determining of a condition of the identified component comprises comparing a freshly recorded image of the component with a previously recorded image of said component.

4. The method of claim 1, wherein the determining of a condition of the identified component comprises using batch information associated with said component.

5. The method of claim 1, wherein the determining of a condition of the identified component is based on environmental conditions associated with the automated storage and retrieval system comprising ambient temperature or ambient pressure.

6. The method of claim 1, wherein identifying the component based on the recorded image comprises reading ID-data associated with the component.

7. The method of claim 1, wherein the determined condition of the identified component is remaining useful life (RUL).

8. The method of claim 1, wherein the determined condition of the component is probability of component failure within a given time window.

9. The method of claim 1, wherein a time for next vehicle maintenance is set based on the determined condition of the vehicle component.

10. The method of claim 1, wherein, if the determined condition of the identified component is not satisfactory, an image of a selected section of the identified component is recorded.

11. The method of claim 10, wherein said section of the component is selected based on at least one of operational data associated with the component comprising data collected during a vehicle testing phase or data collected while the vehicle operates, batch information associated with the component, or environmental conditions associated with the automated storage and retrieval system comprising ambient temperature or ambient pressure.

12. The method of claim 1, wherein the recorded image of the component is recorded by a camera.

13. The method of claim 12, wherein information regarding the identified component is presented on a display.

14. The method of claim 1, wherein the recorded image of the component is recorded by at least one fixed-position camera.

15. The method of claim 14, wherein the remotely operated vehicle is arranged to be rotated prior to the recording of the image of the component.

16. The method of claim 1, wherein the recorded image of the component is recorded by at least one camera of a movable robotic arm.

17. The method of claim 1, wherein selecting the component of the remotely operated vehicle is preceded by identifying the remotely operated vehicle.

18. The method of claim 17, wherein the identifying of the remotely operated vehicle comprises recording an image of the remotely operated vehicle.

19. The method of claim 1, wherein said component is a wheel of the vehicle, a lifting device for vertical transportation of goods holders, a gripper element, a gearbox, a motor belt, or a goods holder contact sensor.

20. A system for determining a condition of a component of a remotely operated vehicle operating on a rail system of an automated storage and retrieval system for goods holders, comprising:
an inspection device comprising a camera for recording an image of the component,
an identifying means configured to identify the component based on the recorded image, and
a determining means arranged to determine condition of the identified component using the recorded image.

21. The system of claim 20, wherein said inspection device is a handheld device comprising a display.

22. The system of claim 20, wherein said system comprises a booth for accommodating a remotely operated vehicle, said booth being provided with said inspection device comprising the camera.

23. The system of claim 22, wherein said camera is at least one fixed-position camera.

24. The system of claim 22, wherein the remotely operated vehicle is rotatable when positioned in said booth.

25. The system of claim 22, wherein said camera is at least one camera provided on a movable robotic arm.

26. The system of claim 20, wherein said component is a wheel of the vehicle, a lifting device for vertical transportation of goods holders, a gripper element, a gearbox, a motor belt or a goods holder contact sensor.

27. An automated storage and retrieval system comprising a framework structure that comprises a plurality of storage columns for storing goods holders, wherein said automated storage and retrieval system comprises a system for determining a condition of a component of a remotely operated vehicle operating on a rail system by executing steps of the method in accordance with claim 1.
